(19) United States
(12) Patent Application Publication
(10) Pub. No.: US 2003/0121295 A1
(43) Pub. Date: Jul. 3, 2003

(54) Padlock arrangement

(76) Inventors: Raimo Lavikainen, Lehmo (FI); Jarno Mertanen, Ylamylly (FI)

Correspondence Address: SMITH-HILL AND BEDELL, 12670 N W BARNES ROAD, SUITE 104, PORTLAND, OR, 97229

(21) Appl. No.: 10/204,105

(22) PCT Filed: Feb. 27, 2001
(86) PCT No.: PCT/FI01/00198

(30) Foreign Application Priority Data
Feb. 29, 2000 (FI) 2000457

(51) Int. Cl. E05B 67/02

(52) U.S. Cl. 70/38 A; 70/52

(57) ABSTRACT

A padlock including a lock body (1), a lock shackle (2) movable between locking and releasing positions, and, inside the lock body, bolt means (5) for securing and releasing the shackle (2) in its locking position, and a cylinder lock mechanism (3) for controlling the bolt means (5). The cylinder lock mechanism (3) is replaceably mounted in a separate casing-like fixing unit (6), which is detachably fixed to the lock body (1). The fixing unit (6) has inner guiding surfaces (6c), which correspond to the outer shape of the cylinder lock mechanism (3, 3′, 3″), to provide both radial and axial support for the cylinder lock mechanism (3, 3′, 3″).

### TECHNICAL FIELD

This invention relates to a padlock of the kind comprising a lock body, a lock shackle movable between locking and releasing positions, and, inside the lock body, bolt means for securing and releasing the shackle in its locking position and a cylinder lock mechanism for controlling the bolt means.

### BACKGROUND OF THE INVENTION

Padlocks are produced in different sizes and forms and can be equipped with different kinds of lock shackles depending on their intended use and required strength properties. Generally each lock manufacturer produces its own lock bodies and lock mechanisms designed for particular uses. Different manufacturers have cylinder locks of different sizes and forms depending on the traditions of lock manufacturers and the practice and norms of different marketing areas. Because of these factors it has not generally been possible to use, for a given design of lock body, different cylinder lock mechanisms providing a series of padlocks of similar appearance but having different intended uses or different geographical areas of use. Instead each manufacturer generally produces a different padlock body for each cylinder lock type.

Padlocks of the kind referred to and having replaceable lock mechanisms are known from U.S. Pat. Nos. 3,835,675 and 4,545,223. Such known padlocks can be operated with different keys by changing the opening combination of the lock mechanism, for example by replacing the whole cylinder lock with another similar type.

### DISCLOSURE OF THE INVENTION

One aim the present invention is to simplify the production and assembly of padlocks so that the same padlock body can be used for different kinds of cylinder lock types. In this way norms and practices of different countries can be taken account of in a better and simpler manner than before whilst allowing the benefits of mass-production to be achieved. It is also an aim of the invention to provide a padlock having improved burglarproof features.

According to the present invention there is provided a padlock as claimed in the ensuing claim 1. With such a design of padlock it is possible to make use of the same lock body in different cylinder lock types. Additionally, due to its casing-like construction, the fixing unit protects the cylinder lock mechanism better than other known releasable cover elements.

It is possible to choose according to the requirement of the padlock the material from which the fixing unit is made. Advantageously the material chosen for the fixing unit will be different from the material of the lock body and/or the cylinder lock mechanism. For example the fixing unit may be made from chilled steel. In this the cylinder lock mechanism itself, or particularly its cylinder and other locking device parts, can be fabricated from cheaper material, without sacrificing the burglarproof properties of the padlock. The same applies also to the padlock body itself which can be made, for example, from brass if the intended use does not require the padlock to be made of steel.

If the guiding surfaces of the fixing unit are formed so that they guide two or several different kinds of cylinder lock mechanisms, the same fixing unit can be used correspondingly for different kinds of lock cylinder mechanisms. In this manner the amount of different stock items can be reduced.

The fixing unit is most favourably formed so that its dimension in a plane perpendicular to the axial direction of the cylinder lock mechanism is essentially greater than its dimension in this axial direction. In this case it can be equipped in practically all issued cylinder lock types, for example with tumbler locks or so called DIN-norm locks and despite of that the basic form of the padlock can be held quite flat.

The fixing unit is able to support different types of lock mechanism. Thus many different types of padlock, each having the same lock body, can be created. Also by providing different fixing units, whose inner guiding surfaces are different and which support different lock mechanisms, even more padlock types can be created for the same lock body.

Design variation possibilities are also enhanced if the cylinder chamber of the lock body is substantially longer than the fixing unit in the axial direction of the cylinder lock mechanism and is formed so as to accommodate different sizes and forms of cylinder lock mechanisms and fixing units.

According to another aspect of the invention there is provided a padlock arrangement as claimed in the ensuing claim 6.

### BRIEF DESCRIPTION OF THE DRAWINGS

Embodiments of the invention will now be described, by way of example only, with particular reference to the accompanying drawings, in which:

FIG. 1 is a sectional view of one embodiment of a padlock according to the invention,

FIG. 2 is a sectional view of another embodiment of a padlock according to the invention, and

FIG. 3 is a perspective view illustrating a partly assembled padlock arrangement comprising a lock body, a fixing unit and two different lock mechanisms which can be selectively mounted in the lock body to create different types of padlock.

### MODES FOR CARRYING OUT THE INVENTION

FIGS. 1 shows a padlock having a lock body 1 in which is received a cylinder lock mechanism 3 and a generally U-shaped lock shackle 2 having a pair of different length legs. The legs are received in bores formed in the lock body 1 and the lock shackle 2 is movable between a locked position (shown in FIG. 1) and a free or releasing position. In the locked position of the shackle 2, bolt means 5, in the form of spherical locking members, are received in notches formed in the legs of the shackle. In the releasing position (not shown), the shorter leg is moved out of its bore in the lock body 1 and the bolt means engages in an annular recess formed in the longer leg of the shackle. In this releasing position the shackle can be turned about the longitudinal axis of the longer shackle leg so that the longer shackle leg turns within the bore of the lock body in which it is received. A turnable torsion device 4 turned by or under the control of the lock mechanism 3 controls the operation of the bolt means 5 in a known manner.

The cylinder lock mechanism 3 is mounted within, and retained fast within, the lock body 1 using a fixing unit 6 which also covers the cylinder lock mechanism 3 in its installed position within the lock body. The fixing unit 6 has a key opening 6a for a key to operate the cylinder lock mechanism 3 and an opening 6b for fastening the fixing unit 6 to the lock body 1 with a screw threaded bolt 7 or the like. The bolt 7 can be accessed for securing or releasing the fixing unit to or from the lock body 1 by means of a tool (not shown) insertable into an opening 1b of the lock body. The bolt 7 can only be accessed after the cylinder lock mechanism 3 is opened with the key of the lock and the lock shackle 2 moved out of its locking position, e.g. into its releasing position so that the longer leg 2a of the shackle 2 does not prevent access to the bolt.

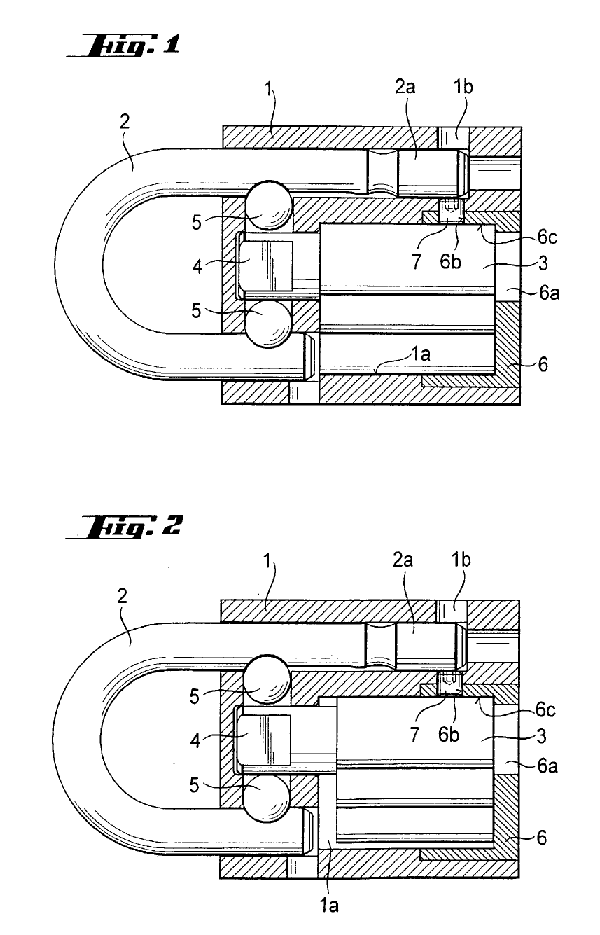

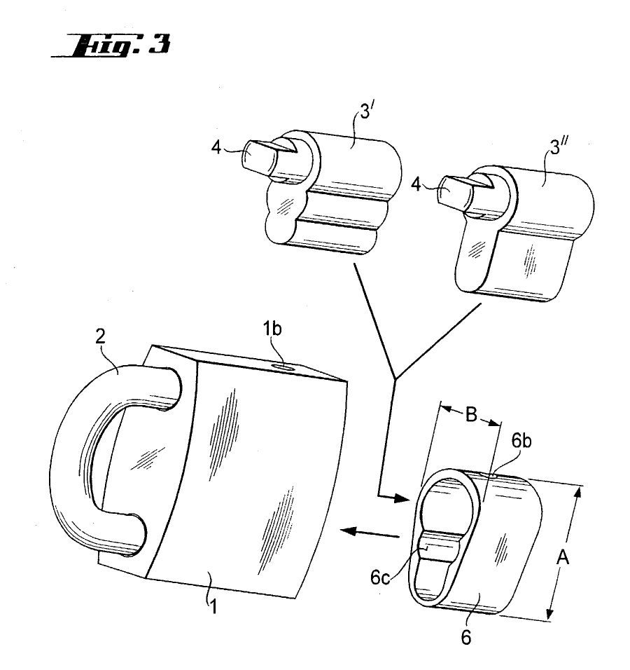

As can be seen from FIGS. 1 and 2, the padlock has a key cylinder 1 a which is able to receive and accommodate different sizes, forms and lengths of cylinder lock mechanisms 3. The different lengths of the cylinder in the axial direction can be easily accommodated by suitable dimensioning of the torsion device 4. The cylinder lock mechanism 3 remains between the inner surface of the key cylinder la and the inner surface of the fixing unit and accordingly receives its axial direction guidance from these surfaces. The radial direction guidance of the cylinder lock mechanism 3 is accomplished by forming the inner surfaces 6c of the fixing unit 6 suitably for outer forms of each cylinder lock mechanisms 3. How this is achieved in this case where the cylinder lock mechanism is distinctly smaller than the key cylinder 1 a itself is shown in FIG. 2.

FIG. 3 illustrates a padlock arrangement for enabling two different cylinder lock mechanisms 3′ and 3″ to be selectively, replaceably received within the lock body 1 using a single fixing unit 6. In particular the inner surfaces 6c of the fixing unit are so formed that they provide axial and radial support for the selected lock mechanism. As can be seen in FIG. 3, the inner surfaces 6c are preferably of generally cylindrical form for receiving correspondingly shaped external surfaces of the cylinder lock mechanisms. Although two lock mechanisms 3′ and 3″ are shown in the padlock arrangement of FIG. 3, it will be appreciated that more than two different lock mechanisms can be provided so that several different padlocks can be created having the same lock body 1.

Because especially in so called tumbler based cylinder locks the dimension of pins' motional direction is greater, it is advantageous for the analogous dimension A of the fixing unit to be substantially greater than the dimension B transverse to it (see FIG. 3). This secures the applicability of the fixing unit 6 for cylinder lock mechanisms with different operating principles which can be assembled in the same lock body 1.

If necessary the arrangement can advantageously include several different fixing units 6, which differ from each other in the design of their inner surfaces. This allows lock mechanisms having differently shaped and/or dimensioned outer surface to be mounted in different fixing units but with the same lock body 1.

The invention is not limited to the embodiments shown but several modifications of the invention are reasonable within the scope of the attached claims.

1. A padlock including a lock body (1), a lock shackle (2) movable between locking and releasing positions, and, inside the lock body, bolt means (5) for securing and releasing the shackle (2) in its locking position, and a cylinder lock mechanism (3) for controlling the bolt means (5), characterised in that the cylinder lock mechanism (3) is replaceably mounted in a separate casing-like fixing unit (6) which is detachably fixed to the lock body (1), and in that the fixing unit (6) has inner guiding surfaces (6c), which correspond to the outer shape of at least two cylinder lock mechanisms (3,3′,3″) of different type, to provide both radial and axial support for the cylinder lock mechanism (3,3′,3″).

2. A padlock according to claim 1, characterised in that the fixing unit (6) is fabricated from different material to that of the lock body (1) and/or the cylinder lock mechanism (3,3′,3″).

3. A padlock according to claim 1 or 2, characterised in that the fixing unit (6) is made from chilled steel.

4. A padlock according to any one of the preceding claims, characterised in that the fixing unit (6) has a maximum first dimension (A) in a plane perpendicular to an axial direction of the cylinder lock mechanism (3,3′,3″) which is larger than a second dimension (B) perpendicular to said first dimension in said plane.

5. A padlock according to any one of the preceding claims, characterised in that a key cylinder (1a) of the lock body is longer in an axial direction of the cylinder lock mechanism than the fixing unit (6) and is formed so that it is possible to install different fixing units (6) made for different sizes and forms of cylinder lock mechanism (3,3′,3″).

6. A padlock arrangement comprising a lock body (1), a lock shackle (2) movable between locking and releasing positions, bolt means (5) for securing and releasing the shackle (2) in its locking position, and at least two cylinder lock mechanisms (3) selectively replaceably positionable in the lock body for controlling the bolt means (5), said cylinder lock mechanisms (3) being replaceably supported in at least one casing-like fixing unit (6) which is detachably fixed to the lock body (1), characterised in that the or each fixing unit (6) has inner guiding surfaces (6c), which correspond to the outer shape of at least two cylinder lock mechanisms (3,3′,3″), that it is intended to support to provide both radial and axial support for the particular cylinder lock mechanism (3,3′,3″) supported in the fixing unit in each case.

7. A padlock arrangement according to claim 6, characterised in that said inner guiding surfaces 46c) of the or each fixing unit (6) are formed so that they guide different kinds of cylinder lock mechanisms (3,3′,3″).

8. A padlock according to claim 6 or 7, characterised in that it comprises different types of fixing units (6) having different inner guiding surfaces (6c).
